(19) United States
(12) Patent Application Publication
(10) Pub. No.: US 2012/0016900 A1
(43) Pub. Date: Jan. 19, 2012

(54) IDENTIFICATION OF THIRD PARTY PIM REPOSITORIES STORING A USER'S CONTACT INFORMATION

(75) Inventors: Scott W. Slinker, San Jose, CA (US); Anthony A. Shah-Nazaroff, Santa Clara, CA (US); James T. Brady, San Jose, CA (US)

(73) Assignee: Jake Knows, Inc., San Jose, CA (US)

(21) Appl. No.: 13/027,058

(22) Filed: Feb. 14, 2011

Related U.S. Application Data
(60) Provisional application No. 61/304,700, filed on Feb. 15, 2010.

(51) Int. Cl. G06F 17/30

(52) U.S. Cl. 707/769; 707/E17.014

(57) ABSTRACT

A system comprises a database containing information concerning uniquely identified individuals, and a processor to identify linkages between the individuals. The linkages are in the form of unique identifiers stored in a contact repository, and provide a first user the ability to use the linkages to construct a database of second individuals that have an identifier of the first individual in a contact repository of one or more second individuals.

### CROSS-REFERENCE TO RELATED PATENT DOCUMENTS

The present application claims the benefit of priority under 35 U.S.C. Section 119(e) to U.S. Provisional Patent Application Ser. No. 61/304,700, filed on Feb. 15, 2010, which application is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, Jake Knows, Inc., All Rights Reserved

### TECHNICAL FIELD

The present disclosure relates to providing security for a user's identity.

### BRIEF DESCRIPTION OF THE DRAWINGS

FIG. 1 is a schematic diagram illustrating an environment within which an example embodiment may be implemented.

FIG. 2 is a representation of a contact graph, according to an example embodiment.

FIG. 3 is a flowchart illustrating operation of a contact application to process a contact transaction, according to an example embodiment.

FIG. 4 is a table depicting a contact transaction, according to an example embodiment.

FIG. 5 is a representation of a person table entry, according to an example embodiment.

FIG. 6 is a table representing a contact list entry, according to an example embodiment.

FIG. 7 is a table showing communication history, according to an example embodiment.

FIG. 8 is a flow chart illustrating a method of indirect contact generation, according to an example embodiment.

FIG. 9 is a table representing a communications log, according to an example embodiment.

FIG. 10 is a table representing a query input, according to an example embodiment.

FIG. 11 is a flow chart representing a method, according to an example embodiment, to build a phone list.

FIG. 12 is a block diagram of a machine in the example form of a computer system within which instructions for causing the machine to perform any one or more of the methodologies discussed herein may be executed

### DETAILED DESCRIPTION

In the following description, for purposes of explanation, numerous specific details are set forth in order to provide a thorough understanding of some example embodiments. It will be evident, however, to one skilled in the art that the present embodiments may be practiced without these specific details.

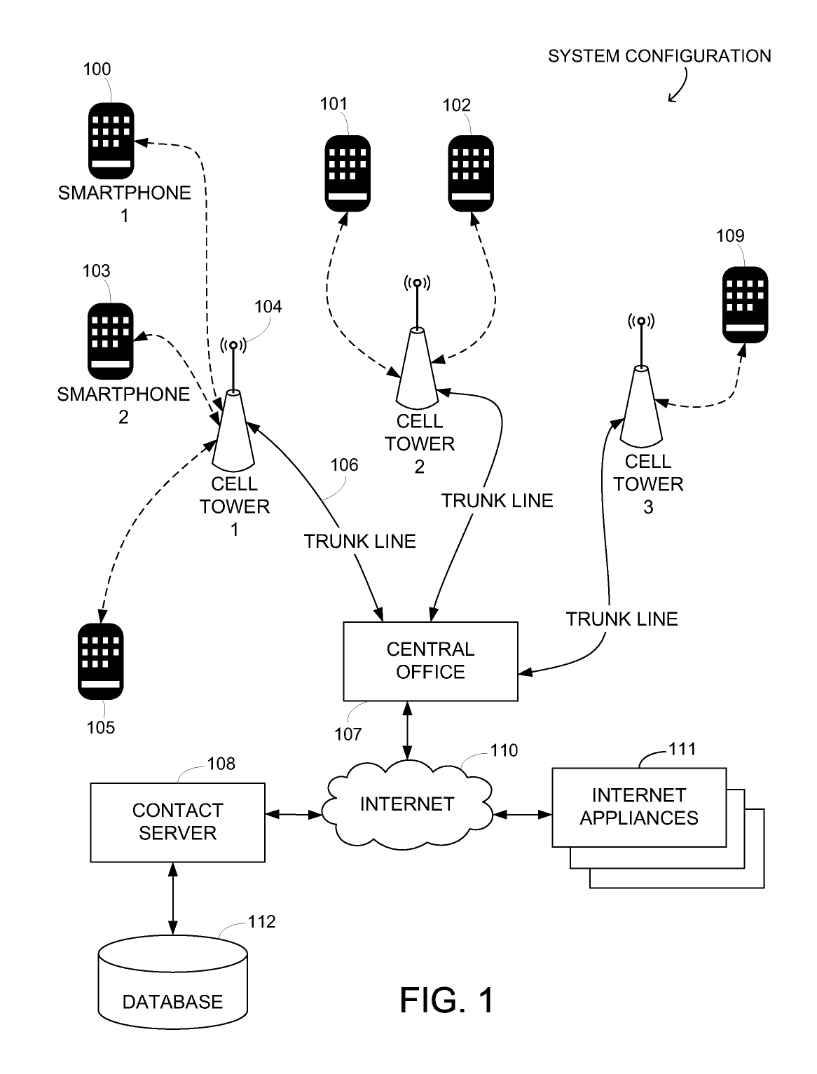

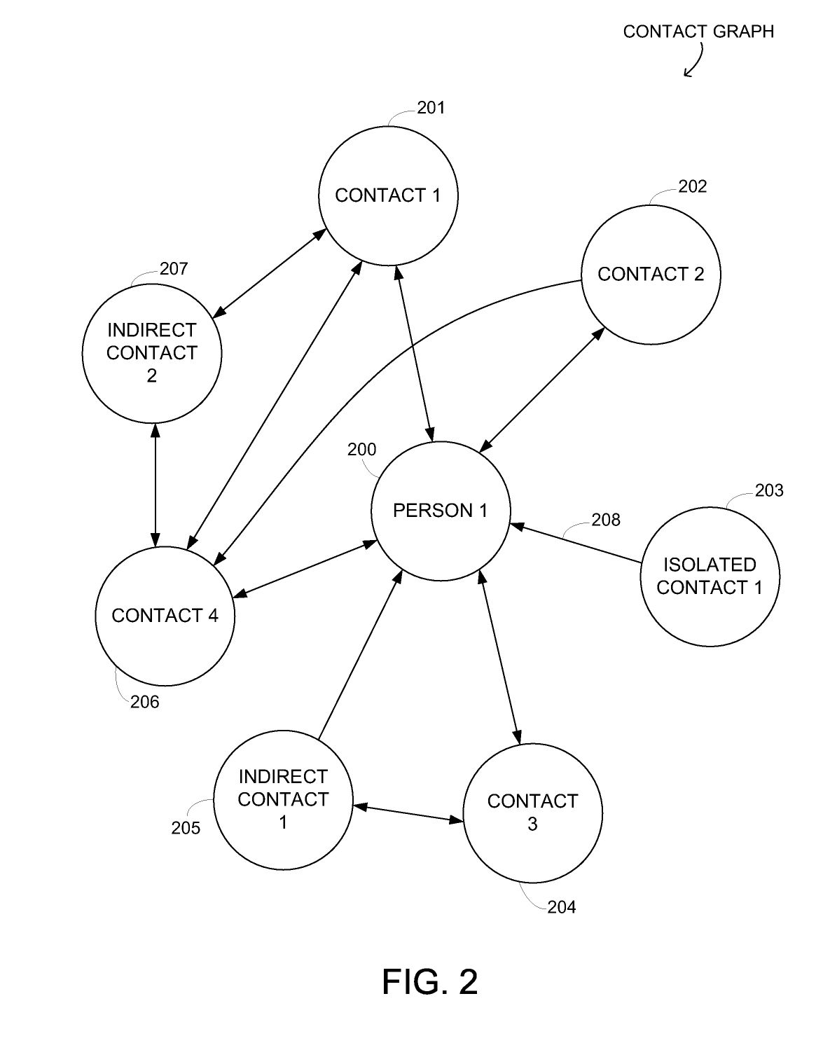

FIG. 1 is a schematic diagram illustrating an environment within which an example embodiment may be implemented. Devices 100, 101, 102, 103, 105, and 109 are smart phones and feature phones (phones), which are connected through the various wireless networks that are currently in place to support communications with the devices 100, 101, 102, 103, 105, and 109. The device 100 connects via the most accessible cell tower 104, via a trunk line 106 to a central office 107 using standard technology. Additionally, Internet appliances 111 are connected through the Internet 110. If the user has activated a client contact application (described in further detail below with reference to FIG. 2) hosted on the device 100 or one of Internet appliances 111, then the client contact application sends a contact transaction requested by the user from the device 100 to the contact server 108 by the above paths to the contact server 108.

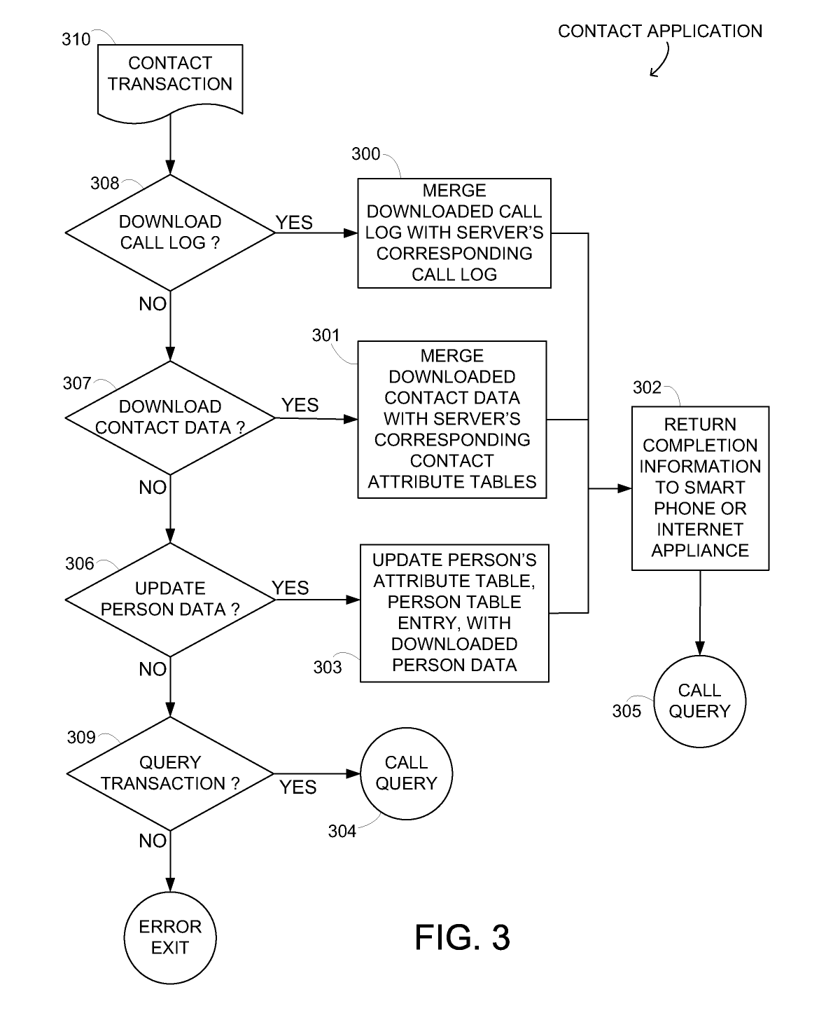

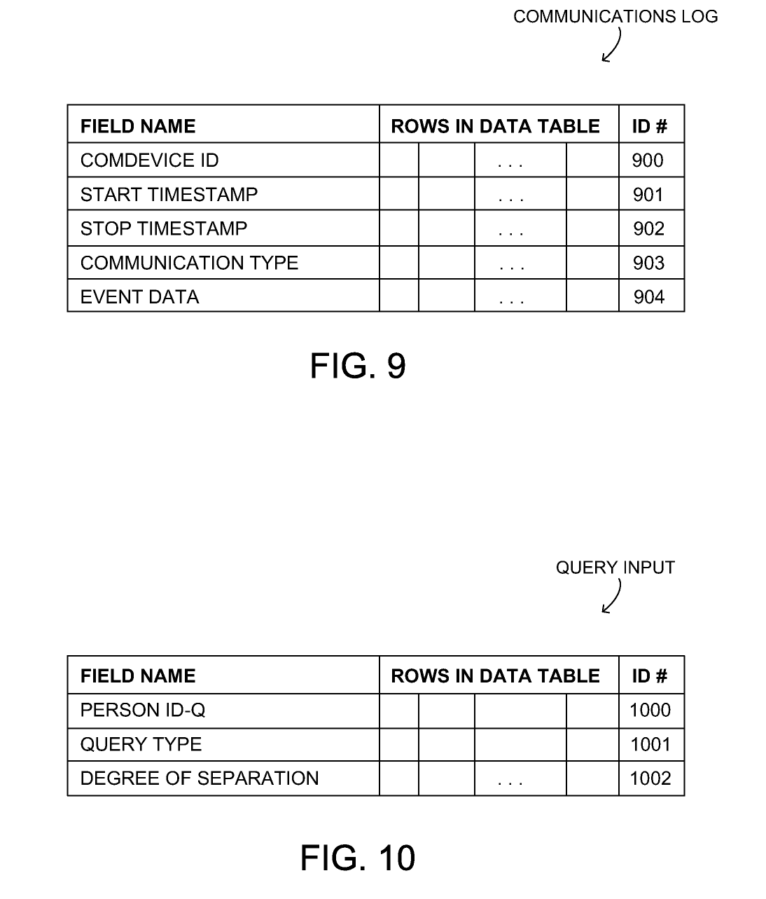

At the contact server 108, a server contact application (e.g., see FIG. 9) processes the transaction as is shown in FIG. 3, updating database 112, which contains table entries, contact table entries, log entries, and metadata needed to support some or all of the foregoing. Note this application is described in terms of the Internet, but the concepts are easily implemented on any digital networking technology.

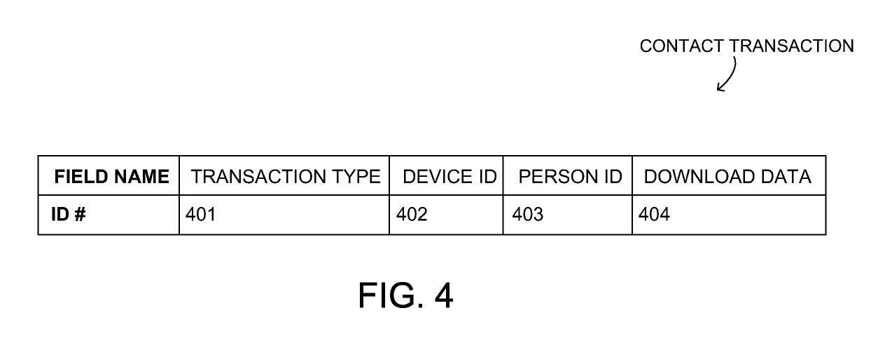

Additionally, contact server 108 can communicate with various Internet appliances 111, which can communicate with Internet sites such as Facebook, MySpace, Gmail, Outlook, and other Internet applications; requesting, collecting and processing the various attributes of persons and contacts. Collectively the phones and Internet appliances are referred to as contact repositories. The data collected from these is formatted into a contact transaction format (see FIG. 4) and processed by the server contact application. By this mechanism, data can be acquired by the system from various sources.

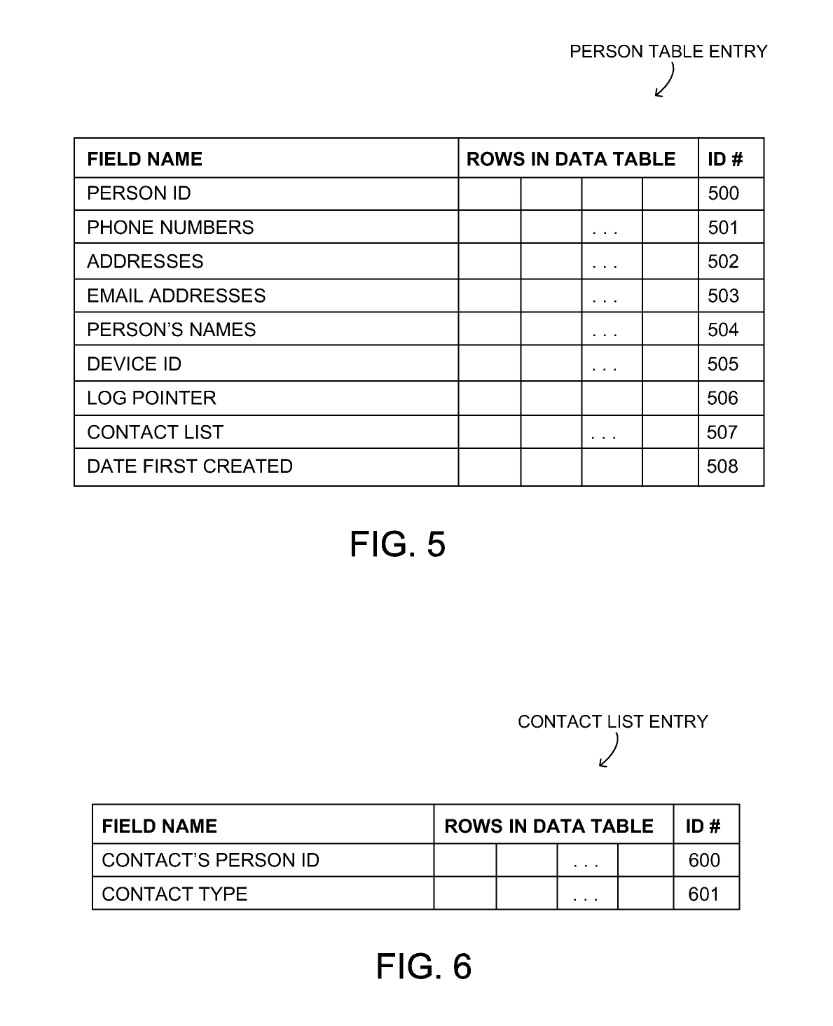

FIG. 2 is a contact graph, and shows that a first individual such as Person 1 at 200 is linked to various other individuals (or second individuals) by the content of the various ID fields found in a person table entry (e.g., see FIG. 5) that describes Person 1. These links are extended by the content of those linked-to individuals' page table entries. In the contact graph of FIG. 2, Person 1 at 200 is in direct and two-way contact with Contact 1 at 201, Contact 2 at 202, Contact 3 at 204, Contact 4 at 206, and is in a second degree contact with Indirect Contact 1 at 205 and Indirect Contact 2 at 207. In addition, Isolated Contact 1 at 203 has Person 1 at 200 as a contact in his contact list 507 of FIG. 5, but Person 1 has no knowledge of Isolated Contact 1 via the links in his contact list 507 of FIG. 5. In an example embodiment, Person 1 is made aware of all of the Contacts, Indirect Contacts, and Isolated Contacts within the database 112 (FIG. 1).

FIG. 3 is a flowchart illustrating operation of a contact application, according to an example embodiment, to process a contact transaction. The contact transaction is received in operation 310 and parsed in operation 308. If it is determined to be a download communications log, control is passed to operation 300 where the information in the download is merged with a log (e.g., see the communications log of FIG. 9), associated with Person ID 500 of FIG. 5, in database 112 of the contact server 108. A completions notice is then sent by operation 302 to the smart phone or Internet appliance that had submitted the transaction. The contact application then waits for the next transaction.

Otherwise the No path is taken from 308 and the transaction is examined in operation 307. If it is determined to be a download contact data transaction, control is passed to operation 301, where the information in the download is merged with the contact list entry and associated with Person ID 500 in the database 112 of the contact server 108. A completions notice is then sent by operation 302 to the smart phone or Internet appliance that had submitted the transaction. The contact application then waits for the next transaction in operation 305.

Otherwise No path is taken from 307 and the transaction is examined in operation 306. If it is determined to be an update person data transaction, control is passed to operation 303 where the information in the download is merged with a person table entry, associated with Person ID 500, in the database 112 of contact server 108. A completions notice is then sent by operation 302 to the smart phone or Internet appliance that had submitted the transaction. The contact application then waits for the next transaction in operation 305.

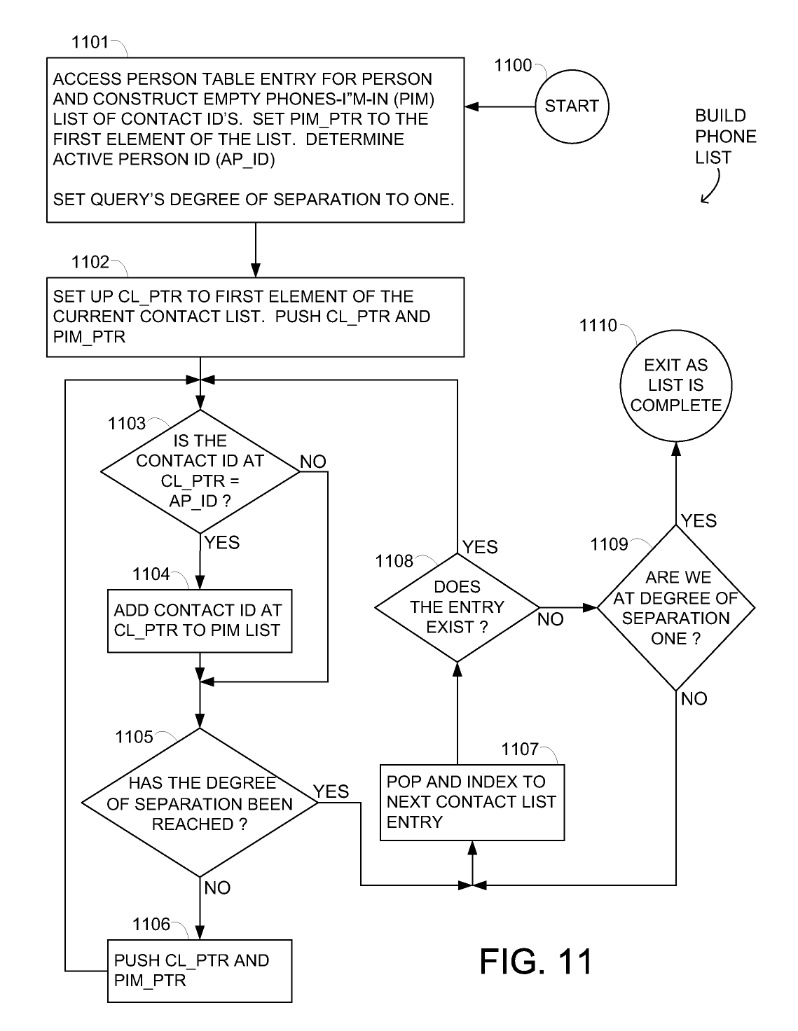

Otherwise the No path is taken from 306 and the transaction is examined in operation 309. If it is determined to be a query transaction, control is passed to operation 304, which calls a build phone list (e.g., see FIG. 11). Control is then given to operation 302, which returns the completion information to the smart phone or Internet appliance, and enters operation 305 and waits for the next transaction.

FIG. 4 is a table depicting a contact transaction, according to an example embodiment. The contact transaction contains information the smart phone or Internet appliances is sending to the server contact application for processing. The contact transaction may include the following example fields: Transaction Type 401, which specifies the kind of transaction submitted; Device ID 402, which is used to match the Device ID 505 in FIG. 5 in the Person Table; Person ID 403, which is used to identify the person the transaction is being processed for; and the Download Data 404, which contains the information for executing the requested FIG. 4 contact transaction.

FIG. 5 is a representation of a person table entry, according to an example embodiment. The person table entry of FIG. 5 describes an individual that is either a member or the contact of the member. The person table entry is stored in a conventional database and can be accessed by one or more of the unique keys, such as Person ID 500, Phone Number 501, Email Address 503 and Device ID 505. It contains one Person ID 500 that identifies the person; one or more Phone Numbers 501 associated with that person; one or more Addresses 502, postal or street, associated with that person; one or more Person's Names 504 that that person uses; one or more Device ID 505, which is a unique ID for each smart phone or feature phone used by the person; a Log Pointer 506, which is a used to find log entries; a Contact List 507 containing a list of person IDs for all the contacts of the person; and Date First Created 508 which is the date the person table entry was created for this person.

FIG. 6 is a table representing a contact list entry, according to an example embodiment. The contact list entry contains a Contact's Person ID 600, which is the unique identifier of a person in a person table entry having a Person ID 500 that is identical to Contact's Person ID 600; and a Contact Type 601, which indicates whether the corresponding contact is a direct or implied contact.

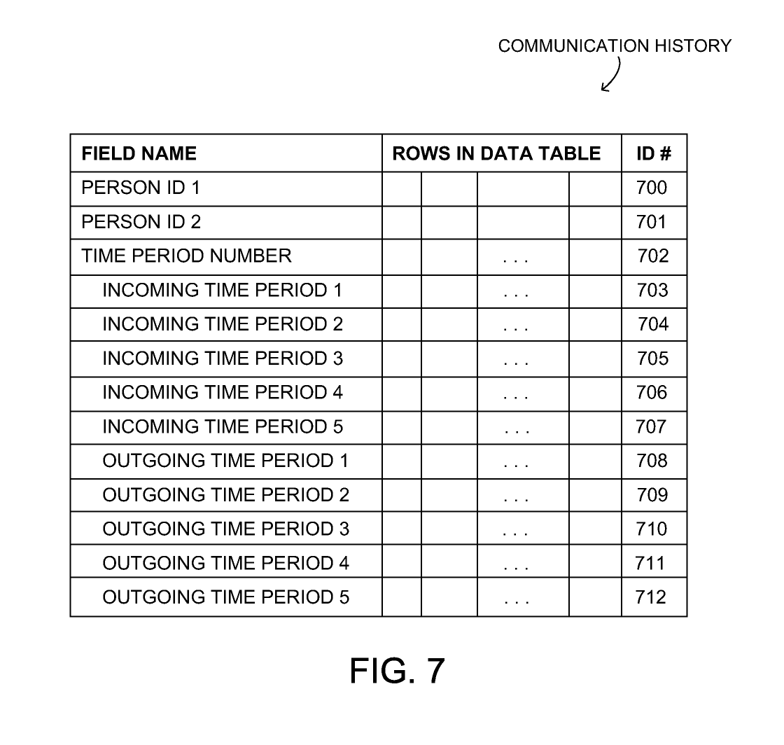

FIG. 7 is a table showing communication history, according to an example embodiment. The communication history describes the communications between a person defined within a person table entry (e.g., that person having Person ID 500 of FIG. 5 which is stored in Person ID 1 700 of FIG. 7) and a contact of that person (having a different Person ID 500, which is stored in Person ID 2 701). The rest of the table contains a summary of communications activity for a plurality of periods for incoming and outgoing communications. They are described by a set of repeating fields herein described by a generic period, which is described as follows: Period Number 702 of FIG. 7 contains sequential integers between 1 and the number (n) of periods being tracked, where n is assigned to the most recent period and one (1) to the least recent period, in an example embodiment. For example, five time periods can be tracked for incoming communications and five time periods can be tracked for outgoing communications. It will be appreciated that other numbers of time periods can be used. Incoming Time Period 1, 703, gives the count of incoming calls to the person from the contact received in Time Period 1; Incoming Time Period 2, 704, gives the count of incoming calls to the person from the contact received in Time Period 2; Incoming Time Period 3, 705, gives the count of incoming calls to the person from the contact received during Time Period 3; Incoming Time Period 4, 706, gives the count of incoming calls to the person from the contact received in Time Period 4; Incoming Time Period 5, 707, gives the count of incoming calls to the person from the contact received in Time Period 5. Outgoing Time Period 1, 708, gives the count of outgoing calls from the person to the contact in Time Period 1; Outgoing Time Period 2, 709, gives the count of outgoing calls from the person to the contact in Time Period 2; Outgoing Time Period 3, 710, gives the count of outgoing calls from the person to the contact in Time Period 3; Outgoing Time Period 4, 711, gives the count of outgoing calls from the person to the contact in Time Period 4; and Outgoing Time Period 5, 712, gives the count of Outgoing calls from the person to the contact in Time Period 5.

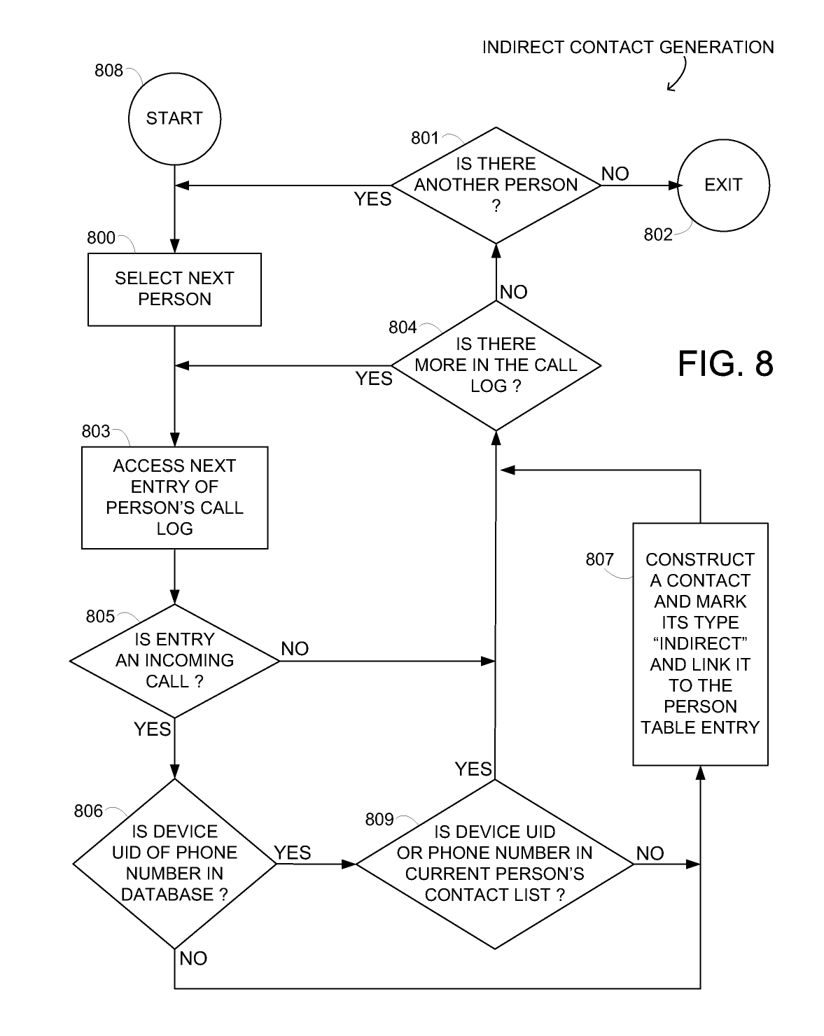

FIG. 8 is a flow chart illustrating a method of indirect contact generation, according to an example embodiment. The method is initiated at operation 808, which transfers control to operation 800 that selects the next person in the database to process and passes control to operation 803. Operation 803 accesses the next entry in the selected person's log and passes control to operation 805.

Operation 805 checks the log to determine if the entry is an incoming call. If so, control is passed to operation 806; otherwise control is passed to operation 804.

Operation 806 determines if the Device ID 505 of FIG. 5 is in the database 112 of FIG. 1. If so, control is passed to operation 809, otherwise control is passed to operation 807.

Operation 809 determines if the Device ID 505 is in one of the contact table entries. If so, an entry for this device exists and the log is skipped by passing control to operation 804. Otherwise, operation 807 adds a contact to the database by constructing a FIG. 6 contact list entry, marking it as “indirect” and adding an additional link in Contact List 507 of FIG. 5 to point to the FIG. 6 Contact List Entry.

Operation 804 checks the log for the current person to determine if there is another communication history entry to process. If so, control is passed to operation 803; otherwise control is passed to operation 801.

Operation 801 determines if there are more persons to process. If so control is passed to operation 800, otherwise the No path is taken from 801 and control is passed to operation 802 which terminates the process.

FIG. 9 is a table representing a communications log, according to an example embodiment. The communications log describes the phone calls and other communications made and received by a Person ID 500 from any of the communications devices in the Person ID 500's Person Table (Person Table Entries are seen in FIG. 5. The communications log of FIG. 9 describes all the communications made and received by a Person ID 500. The fields contained in the communications log may include: ComDevice ID 900, which is a unique ID assigned to the smart phone or Internet appliance; Start Timestamp 901, which contains the date and time the communication started; Stop Timestamp 902, which contains the date and time the communication stopped; Communication Type 903, which indicates the type of call, e.g., call out, call in, call missed, voicemail received, text, email, Facebook posting, etc; and Event Data 904, which contains any text, image, or other digital information associated with the communication.

FIG. 10 is a table representing a query input, according to an example embodiment. The query input is a table generated from a user interface and may be composed of: Person ID-Q 1000, which is an instance of a Person ID 500 which identifies the person making the query; Query type 1001, which specifies what kind of query is being performed (in this case, asking for a display of contact repositories that contain one or more of the unique IDs (Person ID 500, phone numbers 501, addresses 502, email addresses 503, and device ID 505) contained in a person table entry of the person making the query). Query input may also include Degree of Separation 1002, which defines how many links should be included in the query. A Degree of Separation of 2 indicates that just contacts and their contacts should be searched. A Degree of Separation of 1 indicates that just contacts should be searched. One code point is reserved to mean there is no limit on the degree of separation. The query would find contact repositories that could not be found by following links out from the person who is making the query's contact Repository.

FIG. 11 is a flow chart representing a method, according to an example embodiment, to build a phone list. The flow chart depicts operations to develop the list of contacts, indirect contacts, and isolated contacts for a given person represented by a person table entry such as that seen in FIG. 5. This flow chart uses a recursive approach to describe this function but it will be appreciated that other approaches may be used.

At the start 1100, the user accesses the person table entry for person 500 and constructs a Phones-I'm-In list for that person, and sets a pointer (PIMPtr) to the first element of the constructed list, an Active Person ID is set to the current Person IDA and Degree of Separation value is set to one for this example. Then control passes to step 1102. At 1102 CL_Ptr is set to the first element of the current contact list, then the CL_Ptr and PIMPtr are pushed into a stack, and step 1103 uses the top item in the stack to determine if the Active Person ID is set to the Contact ID specified by the CL_Ptr. If Yes, then step 1104 adds the Contact ID to the Phones-I'm-In list and advances the PIMPtr by one. If no, control is passed to step 1105.

Step 1105 checks to see if the Degree of Separation limit has been reached. If Yes, control passes to step 1107. If not, the No path is taken and step 1106 adds one to the Degree of Separation and Pushes CL_Ptr and PIMPtr, then passes control to step 1103.

Step 1107 Pops the stack and indexes to the next entry of the Contact List and subtracts one from the Degree of Separation, then step 1108 determines if the entry exists, if Yes then control passes to step 1103. Otherwise the No path is taken to step 1109 which checks the Degree of Separation to see if it is equal to one. If Yes, the Phones-I'm-In list is complete so control passes to step 1110 which exits the process and returns the list for subsequent use. Otherwise, the No path is taken and control passes to step 1107.

### Modules, Components and Logic

Certain embodiments described herein include logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures may be given consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

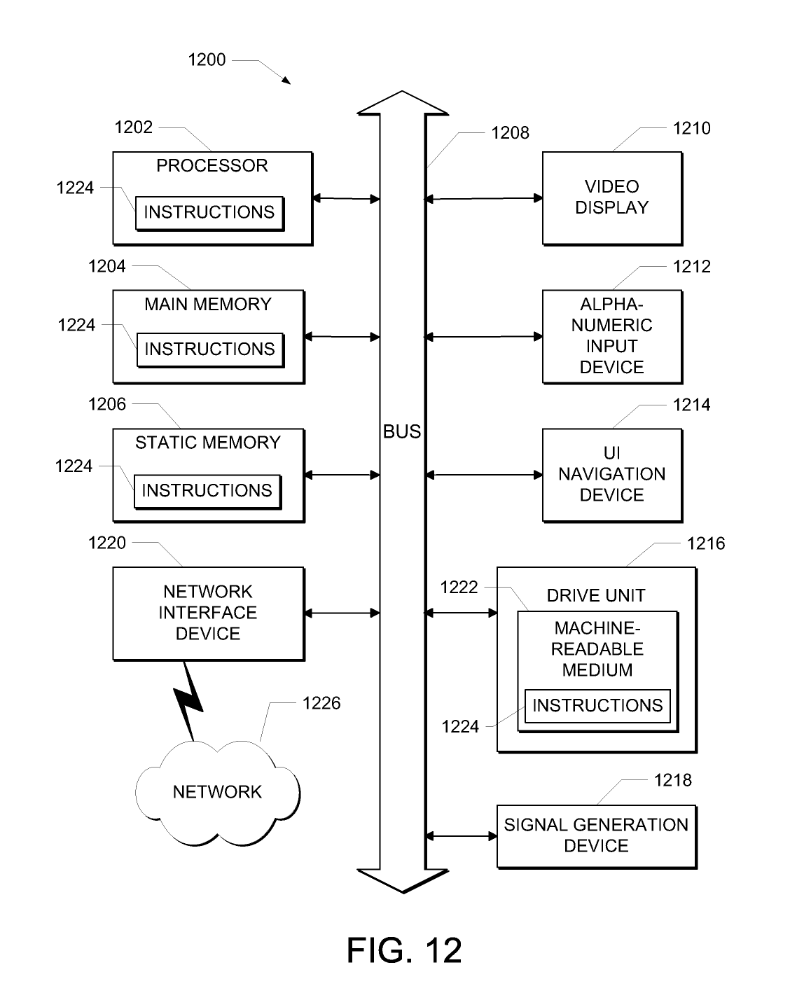

FIG. 12 is a block diagram of a machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the embodiments of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
storage including a database containing information concerning uniquely identified individuals, and
a processor configured to identify linkages between the individuals,
wherein the linkages are in the form of unique identifiers stored in a contact repository, and provide a first individual the ability to use the linkages to construct in the storage a database of second individuals that have an identifier of the first individual in a contact repository of the second individual.

2. The system of claim 1, wherein the database of second individuals is constructed by executing a contact application to process a contact transaction.

3. The system of claim 2, wherein the contact transaction is one of the group consisting of a direct contact, an indirect contact, and an isolated contact.

4. The system of claim 3 wherein the contact transaction is a download communication log transaction comprising downloading information for merging with a log associated with the first individual.

5. The system of claim 3 wherein the contact transaction is a download contact data transaction comprising downloading contact data for merging with a contact list entry associated with the first individual.

6. The system of claim 3 wherein the contact transaction is an update person data transaction comprising downloading person data for merging with an attribute table and a person table entry associated with the first individual.

7. The system of claim 3 wherein the contact transaction is a query transaction comprising building a telephone list associated with the first individual.

8. A method comprising:
using a processor and storage, constructing entries in a database, the entries containing information concerning uniquely identified individuals, and
identifying linkages between the individuals, the linkages being in the form of unique identifiers stored in a contact repository of the uniquely identified individuals,
wherein the linkages provide a first individual the ability to use the linkages to construct in the storage a database of second individuals that have an identifier of the first individual in a contact repository of the second individual.

9. The method of claim 8 the method further constructing the database of second individual by executing a contact application to process a contact transaction.

10. The method of claim 9, wherein the contact transaction is one of the group consisting of a direct contact, an indirect contact, and an isolated contact.

11. The method of claim 10 wherein the contact transaction is a download communication log transaction comprising downloading information for merging with a log associated with the first individual.

12. The method of claim 10 wherein the contact transaction is a download contact data transaction comprising downloading contact data for merging with a contact list entry associated with the first individual.

13. The method of claim 10 wherein the contact transaction is an update person data transaction comprising downloading person data for merging with the attribute table and the person entry table entry associated with the first individual.

14. The method of claim 10 wherein contact transaction is a query transaction comprising building a telephone list associated with the first individual.

15. A non-transitory computer-readable storage medium having embedded therein a set of instructions which, when executed by one or more processors of a computer causes the computer to execute the following operations:
constructing entries in a database, the entries containing information concerning uniquely identified individuals, and
identifying linkages between the individuals, the linkages being in the form of unique identifiers stored in a contact repository of the uniquely identified individuals,
wherein the linkages provide a first individual the ability to use the linkages to construct a database of second individuals that have an identifier of the first individual in a contact repository of the second individual.

16. The storage medium of claim 15, the operations further including constructing the database of second individual by executing a contact application to process a contact transaction.

17. The storage medium of claim 16, wherein the contact transaction is one of the group consisting of a direct contact, an indirect contact, and an isolated contact.

18. The storage medium of claim 17, the operations further comprising downloading information for merging with a log associated with the first individual.

19. The storage medium of claim 17, the operations further comprising downloading contact data for merging with a contact list entry associated with the first individual.

20. The storage medium of claim 17, the operations further comprising downloading person data for merging with the attribute table and the person entry table entry associated with the first individual.

21. The storage medium of claim 17, the operations further comprising building a telephone list associated with the first individual.
